(19) United States
(12) Patent Application Publication
(10) Pub. No.: US 2026/0278488 A1
(43) Pub. Date: Sep. 17, 2026

(54) INFORMATION PROCESSING DEVICE

(71) Applicant: TOYOTA JIDOSHA KABUSHIKI KAISHA, Toyota-shi (JP)

(72) Inventors: Aya YAMADA KAMISAKA, Tokyo (JP); Takayuki YAMABE, Tokyo (JP); Kota HOSHIBA, Tokyo (JP); Ryota NAKANISHI, Tokyo (JP); Hajime TOJIKI, Tokyo (JP)

(73) Assignee: TOYOTA JIDOSHA KABUSHIKI KAISHA, Toyota-shi (JP)

(21) Appl. No.: 19/539,392

(22) Filed: Feb. 13, 2026

(30) Foreign Application Priority Data
Mar. 12, 2025 (JP) 2025-039748

(51) Int. Cl. G06Q 10/06; G06Q 10/10

(52) U.S. Cl. CPC G06Q 10/06; G06Q 10/10

(57) ABSTRACT

An information processing device according to the present disclosure includes a control unit. The control unit is configured to: acquire event information indicating an event of a user; analyze the acquired event information and calculate a value for each of a plurality of indicators; calculate an estimated importance level of the event by integrating the calculated values of the indicators; and output the calculated estimated importance level.

### CROSS-REFERENCE TO RELATED APPLICATION

This application claims priority to Japanese Patent Application No. 2025-039748 filed on March 12, 2025. The disclosure of the above-identified application, including the specification, drawings, and claims, is incorporated by reference herein in its entirety.

### BACKGROUND

### Technical Field

The present disclosure relates to information processing devices.

### Description of Related Art

Japanese Unexamined Patent Application Publication No. 2017-167636 (JP 2017-167636 A) proposes a meeting room reservation system that reassigns reservations according to the importance of each meeting.

### SUMMARY

One object of the present disclosure is to provide a technique of estimating the importance of a wide variety of event types.

An information processing device according to the present disclosure includes a control unit. The control unit is configured to: acquire event information indicating an event of a user; analyze the acquired event information and calculate a value for each of a plurality of indicators; calculate an estimated importance level of the event by integrating the calculated values of the indicators; and output the calculated estimated importance level.

The present disclosure can estimate the importance of a wide variety of event types.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows an example of a situation in which the present disclosure is applied;

FIG. 2 schematically shows an example of a situation in which a value for each indicator is calculated from event information;

FIG. 3 schematically shows an example of a situation in which an estimated importance level is calculated by integrating the calculated values of the respective indicators;

FIG. 4 schematically shows an example of the hardware configuration of an information processing device according to the present disclosure;

FIG. 5 is a flowchart showing an example of a process executed by the information processing device according to the present disclosure; and

FIG. 6 is a flowchart showing an example of a process of adjusting the weights of the weighted sum.

### DETAILED DESCRIPTION OF EMBODIMENTS

For example, conventional systems such as that disclosed in JP 2017-167636 A calculate the importance of a meeting when a meeting room is reserved. The importance is determined based on information such as the participants' positions or whether a participant is a client. For example, the importance can be used to reassign reservations to give priority to highly important meetings, to propose participation in highly important meetings, or to propose attachment of meeting materials if none are attached to a highly important meeting. However, the present inventors have found that such conventional systems have the following issue. Conventional systems cannot determine the importance of more general types of events, including private events. Because determining the importance of general events involves a wide range of indicators, the meeting-specific approach used in conventional systems for determining importance cannot be applied directly.

The information processing device according to the present disclosure includes a control unit. The control unit is configured to: acquire event information indicating an event of a user; analyze the acquired event information and calculate a value for each of a plurality of indicators; calculate an estimated importance level of the event by integrating the calculated values of the indicators; and output the calculated estimated importance level. With this configuration, the user's event can be analyzed based on the plurality of indicators, and the estimated importance level of the event can be calculated based on the values of the respective indicators. Accordingly, even for general events, the device can estimate the importance level in accordance with a plurality of criteria.

As another aspect of the information processing device of the above aspect, the present disclosure may also be implemented as an information processing method that realizes all or part of the foregoing components, as a program, or as a machine- readable storage medium, such as a computer-readable storage medium, in which such a program is stored. The "machine-readable storage medium such as a computer-readable storage medium" refers to a medium that stores information such as a program by electrical, magnetic, optical, mechanical, or chemical action.

### Application Example

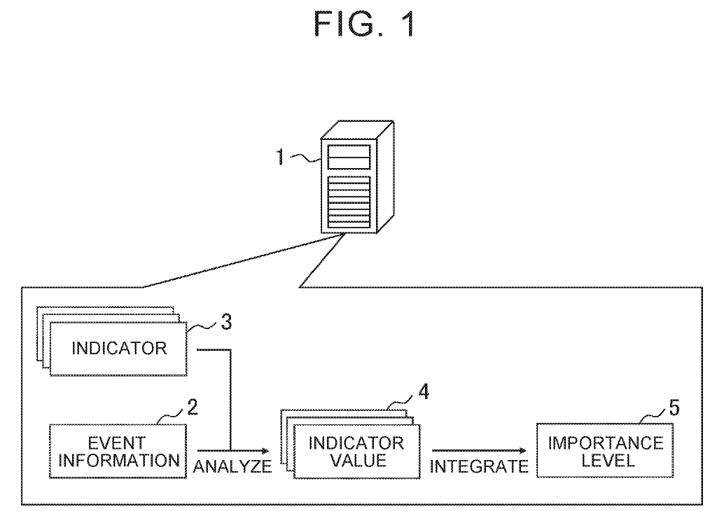

FIG. 1 schematically shows an example of a situation in which the present disclosure is applied. An information processing device 1 according to the present embodiment acquires event information 2 indicating the user U's planned event. The information processing device 1 calculates a value 4 for each of a plurality of indicators 3 by analyzing the acquired event information 2. The information processing device 1 calculates the estimated importance level 5 of the event by integrating the calculated values 4.

### Event Information

The event information 2 may be information indicating the content of the user U's planned event. In one example, the event information 2 may include an event name and an event description. In that case, acquiring the event information 2 may refer to acquiring the event name and the event description. The event name may include a term that identifies the event, such as "meeting," "report," "shopping," or "lunch." The event description may include details of the event. In one example, the event description may include information such as the time, place, or people involved. For example, the time may include information such as the number of days (or hours) until the event, or the day of the week. The place may include information indicating a location such as a workplace (office or meeting room), a destination, home, or a store. The place may be represented as location information. The people involved may include a superior, a colleague, a family member, a friend, or just oneself (i.e., with no other participants). Either the event name or the event description may be omitted.

The method for acquiring the event information 2 is not particularly limited and may be determined as appropriate depending on the embodiment. In one example, the event information 2 may be specified by the user U. When the event information 2 is specified by the user U, the information processing device 1 may accept user specification of either or both of the event name and the event description. Specifying the event name may include selecting one from among a plurality of candidates prepared in advance. In another example, the information processing device 1 may acquire the event information 2 from an external application (such as a scheduling application).

When the information processing device 1 calculates the estimated importance level 5 of the event information 2, it may analyze the event information 2 and calculate a value 4 for each of the indicators 3. The method for calculating a value 4 for each of the indicators 3 may be determined as appropriate. The information processing device 1 may calculate a value 4 for each indicator 3 based on information extracted by analyzing the event information 2. Analyzing the event information 2 may include extracting, from the event information 2, information for use in calculating a value 4 for each indicator 3. By evaluating the event information 2 from a plurality of perspectives in this manner, the accuracy of the estimated importance level 5 can be improved. The content of the indicators 3 is not particularly limited and may be determined as appropriate depending on the embodiment. The indicators 3 may be defined in advance. In that case, the information processing device 1 may store the indicators 3 in memory resources or may acquire the indicators 3 from another computer.

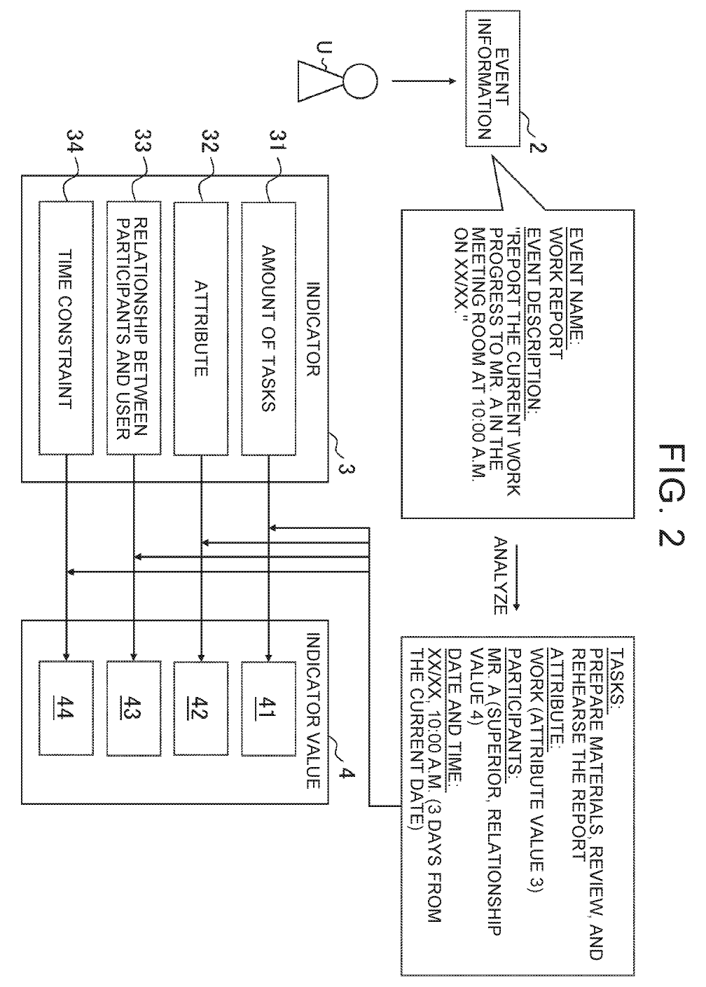

FIG. 2 schematically shows an example of a situation in which a value 4 for each indicator 3 is calculated from the event information 2. In one example, the indicators 3 may include the amount of tasks 31 included in the event, the attribute 32 of the event, the relationship 33 between the event participants and the user U, and the time constraint 34 of the event. In the example shown in FIG. 2, it is assumed that the event name in the event information 2 is "Work Report," and the event description is "Report the current work progress to Mr. A in the meeting room at 10:00a.m. on XX/XX." The indicators 3 are composed of the above indicators (31 to 34).

### Calculation of Value for Amount of Tasks

When the indicator 3 is the amount of tasks 31 included in the event, the method for calculating the value 41 for the amount of tasks 31 by analyzing the event information 2 is not particularly limited and may be determined as appropriate. In one example, calculating the value 41 by analyzing the event information 2 may include extracting tasks from the information contained in the event information 2 and setting the number of extracted tasks as the value 41. Any known method may be used to extract the tasks.

In one example, tasks may be set in advance for each piece of event information 2 (i.e., for each event name). Accordingly, extracting tasks from the information contained in the event information 2 may include identifying the tasks set in advance for each event name. The tasks corresponding to each event name may be set in advance by the user U or may be set by default. Alternatively, the tasks may be set based on data from users having attributes that are the same as or similar to those of the user U. In the example shown in FIG. 2, when the event name is "Work Report," "prepare materials," "review," and "rehearse the report" are set in advance as the tasks. Since three tasks are extracted, the information processing device 1 may determine the value 41 to be three.

In another example, the tasks may be dynamically extracted according to the event information 2. The method for dynamically setting tasks may be determined as appropriate. In the example shown in FIG. 2, since the event description includes location information (meeting room), the information processing device 1 may add "reserve the meeting room" to the tasks ("prepare materials," "review," and "rehearse the report") set in advance for the event "Work Report." Because four tasks are extracted, the information processing device 1 may determine the value 41 to be four.

The method for calculating the value 41 by analyzing the event information 2 is not limited to the above examples. In another example, calculating the value 41 by analyzing the event information 2 may include extracting tasks from the information contained in the event information 2, acquiring the time it takes to perform each extracted task, calculating the total time (execution time) it takes to complete all the tasks, and setting the execution time as the value 41. The method for obtaining the time it takes to perform each task and the method for calculating the execution time are not particularly limited and may be determined as appropriate. For example, the time it takes to perform each task may be set in advance. The set time may be specified by the user U or may be determined based on data from users having attributes that are the same as or similar to those of the user U.

### Calculation of Value for Attribute

In one example, when the indicator 3 is the attribute 32 of the event, the method for calculating the value 42 for the attribute 32 by analyzing the event information 2 is not particularly limited and may be determined as appropriate. In one example, calculating the value 42 by analyzing the event information 2 may include extracting the attribute from the information contained in the event information 2 and setting the value corresponding to the extracted attribute as the value 42. Any known method may be used to extract the attribute.

In one example, an attribute may be set in advance for each piece of event information 2 (i.e., for each event name). Accordingly, extracting the attribute from the event information 2 may include identifying the attribute set in advance for each event name. The attribute corresponding to each event name may be set in advance by the user U or may be set by default. For example, the attributes may include work, home, study, and hobby. A value may be set in advance for each attribute. The set value may be any value. In the example shown in FIG. 2, when the event name is "Work Report," "work" is set in advance as the attribute. Since the value (attribute value) corresponding to the attribute "work" is set to three, the information processing device 1 may determine the value 42 to be three.

### Calculation of Value for Relationship between Participants and User

In one example, when the indicator 3 is the relationship 33 between the event participants and the user U, the method for calculating the value 43 for the relationship 33 by analyzing the event information 2 is not particularly limited and may be determined as appropriate. In one example, calculating the value 43 by analyzing the event information 2 may include extracting participants from the information contained in the event information 2, extracting the relationship between the participants and the user U, and setting the value corresponding to the extracted relationship as the value 43. Any known method may be used to extract the participants and to extract the relationship between the participants and the user U.

In one example, participants may be set in advance for each piece of event information 2 (i.e., for each event name). Accordingly, extracting the participants from the event information 2 may include identifying the participants set in advance for each event name. The participants for each event name may be set in advance by the user U. In another example, the participants may be extracted according to the event information 2 (i.e., the event description). The information processing device 1 may extract the participants by analyzing the event description in the event information 2. The relationship between each participant and the user U may be set in advance. Accordingly, extracting the relationship between the participants and the user U may include identifying the relationship set in advance for each participant. The relationship for each participant may be set in advance by the user U. For example, the relationships may include family, superior, subordinate, colleague, client, and friend. A value may be set in advance for each relationship. The set value may be any value. In the example shown in FIG. 2, the event description is analyzed and the participant "Mr. A" is extracted. When the participant is "Mr. A," "superior" is set as the relationship. Since the value (relationship value) for the relationship "superior" is set to four, the information processing device 1 may determine the value 43 to be four.

### Calculation of Value for Time Constraint

In one example, when the indicator 3 is the time constraint 34 of the event, the method for calculating the value 44 for the time constraint 34 by analyzing the event information 2 is not particularly limited and may be determined as appropriate. In one example, calculating the value 44 by analyzing the event information 2 may include extracting the date and time of the event from the information contained in the event information 2 and setting the value corresponding to the extracted date and time as the value 44. Any known method may be used to extract the date and time of the event.

In one example, the date and time of the event may be extracted according to the event information 2 (i.e., the event description). The information processing device 1 may extract the date and time of the event by analyzing the event description in the event information 2. The value corresponding to the date and time of the event may be defined as desired. For example, the value corresponding to the date and time of the event may be the reciprocal of the time remaining until the date and time of the event from the current time. The time remaining until the date and time of the event may be calculated in days or hours. Alternatively, for example, the value corresponding to the date and time of the event may be defined according to the day of the week of the event. In the example shown in FIG. 2, the event description is analyzed, and "10:00a.m. on XX/XX" is extracted as the date and time of the event. The number of days from the current time until the date and time of the event is calculated to be three. When the reciprocal of the number of days until the date and time of the event is used as the value corresponding to the date and time, the information processing device 1 may determine the value 44 to be 1/3.

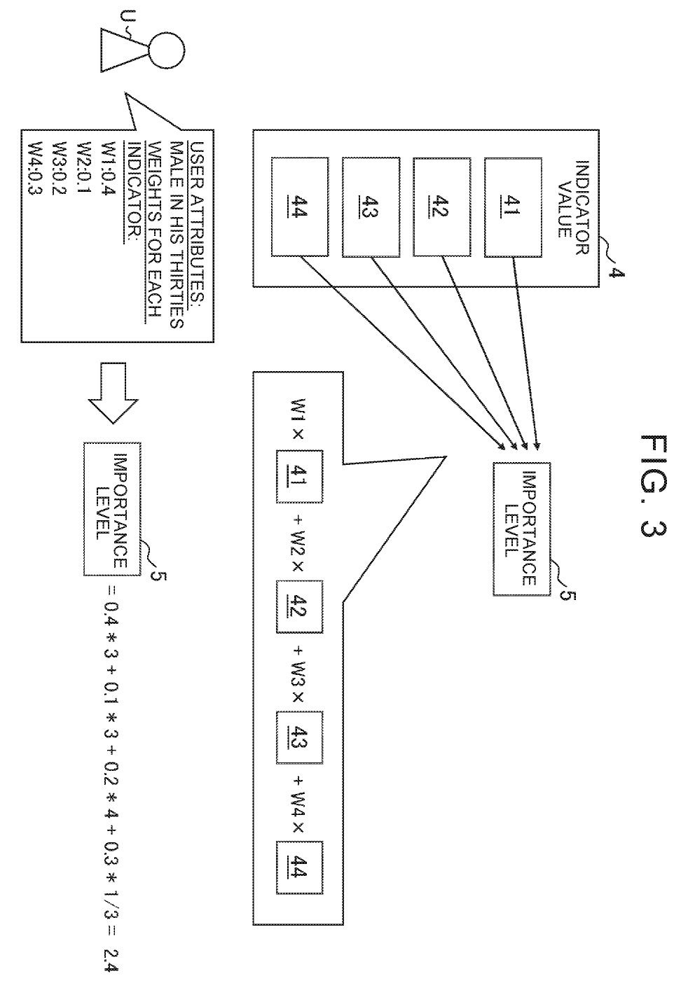

FIG. 3 schematically shows an example of a situation in which the estimated importance level 5 is calculated by integrating the calculated values 4 of the respective indicators 3. In one example, integrating the calculated values 4 of the respective indicators 3 may include calculating a weighted sum of the calculated values 4 of the respective indicators 3. Calculating the weighted sum may include calculating a statistical value such as a weighted average. That is, the calculated weighted sum may be directly used as the estimated importance level 5, or the calculated weighted sum may be converted into another statistical value such as a weighted average and used as the estimated importance level 5.

In one example, the weights of the weighted sum may be defined in advance. In the example shown in FIG. 3, the weights (W1 to W4) are defined for each of the indicators 3 (31 to 34). The method for determining the weights is not particularly limited and may be selected as appropriate depending on the embodiment. For example, the weights may be specified by the user U. In that case, the information processing device 1 may accept input from the user U specifying the weight for each indicator 3. The information processing device 1 may store the weights specified by the user U and use them for the calculation of the weighted sum. Alternatively, the weights may be determined according to the attributes of the user U. For example, the weights may be determined based on data on other users having attributes that are the same as or similar to those of the user U. The attributes of the user U may include age, gender, address, family structure, and preferences. The items constituting the attributes may be selected as appropriate. The information processing device 1 may store the weights determined according to the attributes of the user U and use them for the calculation of the weighted sum. The attributes of the user U and the data on other users may be acquired by any method.

For example, in the example shown in FIG. 3, it is assumed that the attribute of the user U is "male in his 30s," and that the weights corresponding to this attribute are set as W1 = 0.4, W2 = 0.1, W3 = 0.2, and W4 = 0.3. It is also assumed that the event information 2 is the same as that shown in FIG. 2, and that the values 4 (41 to 44) of the indicators 3 (31 to 34) are determined as described above. In this case, the estimated importance level 5 is calculated as 0.4 × 3 + 0.1 × 3 + 0.2 × 4 + 0.3 × 1/3 = 2.4 by calculating the weighted sum.

The weights of the weighted sum may be adapted to the user U. That is, the weights for the respective indicators 3 may be adjusted by comparing the estimated importance level 5 for an event of the user U (event information 2) with whether the event was actually important. The method for determining whether an event was important is not particularly limited and may be determined as appropriate. In one example, whether an event was important may be determined according to the user U's behavioral record for the event. Whether an event was important may be defined as the actual importance level.

In one example, the weights of the weighted sum may be adjusted through machine learning using the user U's behavioral records for past events. Machine learning adjusts (optimizes) the values of the calculation parameters (the weights of the weighted sum) using training samples. In one example, as a machine learning process, the information processing device 1 may perform supervised learning using a plurality of datasets. Each dataset may include a past event (input sample) of the user U and the actual importance level (correct label) of that event. The actual importance level may be derived from the behavioral record for the event. In one example, the behavioral record may include whether the user participated in the event, whether a reminder was set, the amount of time invested, and whether or how many times the event was mentioned on social media. The behavioral record may be acquired as appropriate. The method for deriving the actual importance level from the behavioral record is not particularly limited and may be determined as appropriate depending on the embodiment. In supervised learning, the weights of the weighted sum may be adjusted (optimized) such that the value calculated by the weighted sum of the values 4 of the respective indicators 3 when the event (event information 2) is provided matches the corresponding actual importance level (correct label). The error between the output value for the input sample and the correct label (actual importance level) may be calculated by a loss function, and adjusting the weights through machine learning may include determining the weights so as to minimize the loss function. However, the method of machine learning is not limited to this example and may be modified as appropriate depending on the embodiment. The adjustment of the weights of the weighted sum through machine learning may be performed by another computer instead of the information processing device 1. The information processing device 1 may acquire the adjusted weights from another computer and use the acquired weights to integrate the values 4 of the respective indicators 3.

By adjusting the weights of the weighted sum based on feedback for the estimated importance level 5 as described above, the accuracy of the estimated importance level 5 can be improved. Since this feedback is based on the behavioral record of the user U, the configuration of the present embodiment makes it possible to calculate a personalized estimated importance level 5 for the user U.

### Output of Estimated Importance Level

The estimated importance level 5 may be output in any format. In one example, outputting the estimated importance level 5 may include directly outputting the value calculated as the result of integrating the values 4 of the respective indicators 3. In another example, outputting the estimated importance level 5 may include outputting the result of any information processing applied to the value calculated as the result of integrating the values 4 of the respective indicators 3. For example, the information processing device 1 may classify the calculated value into levels according to any criterion. The number of levels and the reference values for the classification may be defined as desired. The output destination of the estimated importance level 5 is not particularly limited and may be determined as appropriate depending on the embodiment.

The output estimated importance level 5 may be used for any purpose. In one example, the information processing device 1 may execute any information processing according to the estimated importance level 5. For example, when the estimated importance level 5 is high, the information processing device 1 may propose participation in the event or attachment of related materials. When the estimated importance level 5 is low, the information processing device 1 may propose replacing the event with another. Outputting the estimated importance level 5 may include outputting such a proposal for replacement.

### Configuration Example

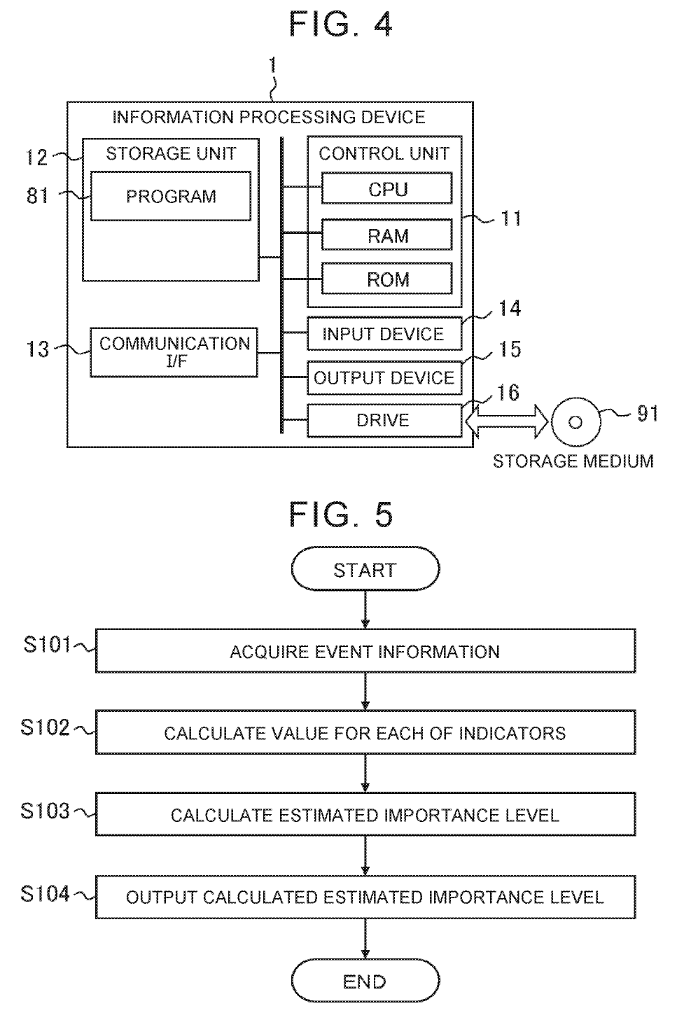

FIG. 4 schematically shows an example of the hardware configuration of the information processing device 1 according to the present disclosure. As shown in FIG. 4, the information processing device 1 according to the present embodiment is a computer in which a control unit 11, a storage unit 12, a communication interface 13, an input device 14, an output device 15, and a drive 16 are electrically connected to each other. The control unit 11 includes a central processing unit (CPU), a random access memory (RAM), a read-only memory (ROM), and the like, and is configured to execute any information processing. The storage unit 12 may be implemented by, for example, a hard disk drive or a solid-state drive. In the present embodiment, the storage unit 12 stores a program 81. The program 81 is a program for causing the information processing device 1 to execute the information processing according to the present embodiment. The program 81 includes a series of instructions for such information processing.

The communication interface 13 is configured to perform data communication, either wired or wireless, via a network. The communication interface 13 may be implemented by, for example, a wired local area network (LAN) module or a wireless LAN module. In the present embodiment, the information processing device 1 may perform data communication with another computer (for example, an external server) via a network using the communication interface 13. The input device 14 is a device for input operations, such as a mouse, keyboard, button, joystick, or control. The output device 15 is a device for output operations, such as a display or speaker. The input device 14 and the output device 15 may be integrated as, for example, a touch panel display.

The drive 16 is a device that reads various kinds of information, such as programs, stored in a storage medium 91. The program 81 may be stored in the storage medium 91 instead of, or in addition to, the storage unit 12. The storage medium 91 is configured to store various kinds of information (such as programs) by electrical, magnetic, optical, mechanical, or chemical action such that a machine such as a computer can read the information. The information processing device 1 may acquire the program 81 from the storage medium 91. The storage medium 91 may be a disk storage medium such as a compact disc (CD) or digital versatile disc (DVD), or a non-disk storage medium such as a semiconductor memory (for example, flash memory). The type of the drive 16 may be selected as appropriate according to the type of the storage medium 91.

The specific hardware configuration of the information processing device 1 may be modified as appropriate depending on the embodiment. Components may be omitted, replaced, or added as appropriate. For example, the control unit 11 may include a plurality of hardware processors. Each hardware processor may be implemented by a microprocessor, a field-programmable gate array (FPGA), a digital signal processor (DSP), a graphics processing unit (GPU), an application-specific integrated circuit (ASIC), or the like.

### Operation Example

FIG. 5 is a flowchart showing an example of a process executed by the information processing device 1 according to the present disclosure. The following process is an example of an information processing method executed by a computer. However, the following process is merely an example, and each step may be modified as appropriate. Steps in the following process may be omitted, replaced, or added as appropriate depending on the embodiment.

### Steps S101 to S102

In step S101, the control unit 11 acquires the event information 2. In one example, the event information 2 may include an event name and an event description. In step S102, the control unit 11 analyzes the acquired event information 2 and calculates the values 4 for the respective indicators 3. In one example, the indicators 3 may include at least two selected from the amount of tasks 31 included in the event, the attribute 32 of the event, the relationship 33 between the event participants and the user U, and the time constraint 34 of the event. The control unit 11 may analyze the event information 2 to extract information for use in calculating the values 4 of the respective indicators 3. The control unit 11 may calculate the values 4 (values 41 to 44) based on the extracted information.

### Steps S103 to S104

In step S103, the control unit 11 may calculate the estimated importance level 5 by integrating the calculated values 4 of the respective indicators 3. In one example, the integration may be performed by calculating the weighted sum of the calculated values 4 of the respective indicators 3. The weights of the weighted sum may be defined in advance. For example, the weights may be determined according to the attributes of the user U. In step S104, the control unit 11 outputs the calculated estimated importance level 5. The output format and output destination are not particularly limited and may be determined as appropriate depending on the embodiment. When this step is completed, the control unit 11 ends the process.

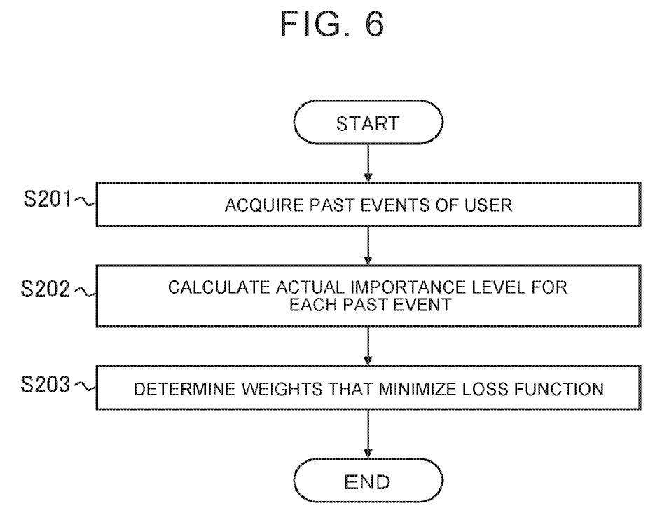

FIG. 6 is a flowchart showing an example of a process of adjusting (optimizing) the weights (W1 to W4) of the weighted sum. The adjustment of the weights may be performed by the information processing device 1 or by another computer. The following process shows an example in which the adjustment of the weights is performed by the information processing device 1.

In step S201, the control unit 11 acquires past events (event information 2) of the user U. In step S202, the control unit 11 calculates the actual importance level for each acquired event. The method for calculating the actual importance level is not particularly limited as long as it is calculated based on the actual behavioral record of the user U and may be determined as appropriate depending on the embodiment. In step S203, the control unit 11 determines the weights (W1 to W4) that minimize the loss function. The loss function may be defined as a function that evaluates the difference between the estimated importance level 5 and the actual importance level. For example, the loss function may be the mean squared error or the mean absolute error. When the weights have been determined, the control unit 11 ends the process.

The above steps S201 to S203 may be executed each time a new event of the user U and the behavioral record of the user U for that event are added. That is, the weights (W1 to W4) may be updated based on data including the newly added event and its actual importance level.

### Features

In the present embodiment, in step S102, the values 4 of the respective indicators 3 are calculated by analyzing the event information 2. In step S103, the estimated importance level 5 is calculated by integrating the calculated values 4 of the respective indicators 3 through the calculation of a weighted sum. The event information 2 is thus evaluated from a plurality of perspectives and the evaluation values from those perspectives are integrated. Accordingly, it is possible to calculate a highly accurate estimated importance level 5 even for a wide variety of event types. The weights of the weighted sum can be adjusted based on the behavioral record of the user U. Accordingly, a personalized estimated importance level 5 for each user U can be calculated.

### Modifications

Although the embodiment of the present disclosure has been described in detail above, the foregoing description is merely illustrative in all respects. It is to be understood that various modifications and variations can be made without departing from the scope of the present disclosure. The processes and means described in the present disclosure may be freely combined and implemented, as long as no technical inconsistencies arise.

What is claimed is:

1. An information processing device comprising a control unit, wherein the control unit is configured to
acquire event information indicating an event of a user,
analyze the acquired event information and calculate a value for each of a plurality of indicators,
calculate an estimated importance level of the event by integrating the calculated values of the indicators, and
output the calculated estimated importance level.

2. The information processing device according to claim 1, wherein the indicators include at least two selected from an amount of tasks included in the event, an attribute of the event, a relationship between a participant in the event and the user, and a time constraint of the event.

3. The information processing device according to claim 1, wherein the integrating the calculated values of the indicators includes calculating a weighted sum of the calculated values of the indicators.

4. The information processing device according to claim 3, wherein weights of the weighted sum are defined in advance.

5. The information processing device according to claim 3, wherein weights of the weighted sum are adjusted through machine learning using behavioral records for past events of the user.
